(19) United States
(12) Patent Application Publication
(10) Pub. No.: US 2003/0151780 A1
(43) Pub. Date: Aug. 14, 2003

(54) Assembly of portable scanning device and PDA

(76) Inventor: Chung-Hua Tsai, Hsinchu City (TW)

Correspondence Address: Jason Z. LIN., 19597 Via Monte Drive, Saratoga, CA, 95070, US

(21) Appl. No.: 10/071,123

(22) Filed: Feb. 8, 2002

(51) Int. Cl. H04N 1/04

(52) U.S. Cl. 358/474

(57) ABSTRACT

A scanning device includes a body having an engaging recess so as to receive a PDA therein. A scanner is received in one of two ridges of the body an active shaft is connected to a side of the scanner and a first gear wheel is connected to an end of the active shaft. A second gear wheel is connected to the other side of the scanner and the first gear wheel and the second gear wheel are located at outside of the body of the scanning device. A transmission assembly is engaged with the first gear wheel and the second gear wheel. An optical sensing assembly is co-rotatably engaged with the transmission assembly so as to transfer the speed signal of the movement of the scanning device to the PDA to adjust the moving speed of scanning.

### FIELD OF THE INVENTION

The present invention relates to a scanning device which has an engaging recess for being connected to a PDA and a transmission device on the scanning device so as to transfer scanned image to the PDA.

### BACKGROUND OF THE INVENTION

There are three types of conventional scanning devices which includes document feeding type, flat bad type and portable type. The portable scanning device is held by the user and moved over the document to scan the context on the document. It is important, nevertheless, difficult to keep a stable moving speed when scanning. The quality of the scanning is not satisfied because the scanning device cannot be moved at a constant speed. Besides, the scanned imagines are not able to be checked during scanning.

### SUMMARY OF THE INVENTION

In accordance with one aspect of the present invention, there is provided a scanning device which comprises an engaging recess defined between two ridges on two sides of a body of the scanning device. A PDA is received in the engaging recess.

A scanner is received in one of the two ridges and an active shaft is connected to a side of the scanner and a first gear wheel is connected to an end of the active shaft. A second gear wheel is connected to the other side of the scanner and both of the first gear wheel and the second gear wheel are located at outside of the body of the scanning device. A transmission assembly is engaged with the first gear wheel and the second gear wheel.

An optical sensing assembly is co-rotatably engaged with the transmission assembly so that when moving the scanning device on document, the speed can be transferred to the PDA by signals by the optical sensing assembly.

The primary object of the present invention is to provide a scanning device that is connected to a PDA so as to check the scanned images on the PDA.

Another object of the present invention is to adjust the speed of receiving the images according to the moving speed of the scanning device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the scanning device of the present invention;

FIG. 2 is a perspective view to show the scanner, the transmission assembly and the optical sensing assembly in the scanning device of the present invention;

FIG. 3 shows the scanning device is moved on a sheet of document;

FIG. 4 shows that the first gear wheel and the second gear wheel of the scanning device are moved on a sheet of document, and

FIG. 5 shows a PDA is able to be received in the scanning device of the present invention.

### DETAILED DESCRIPTION OF THE INVENTION

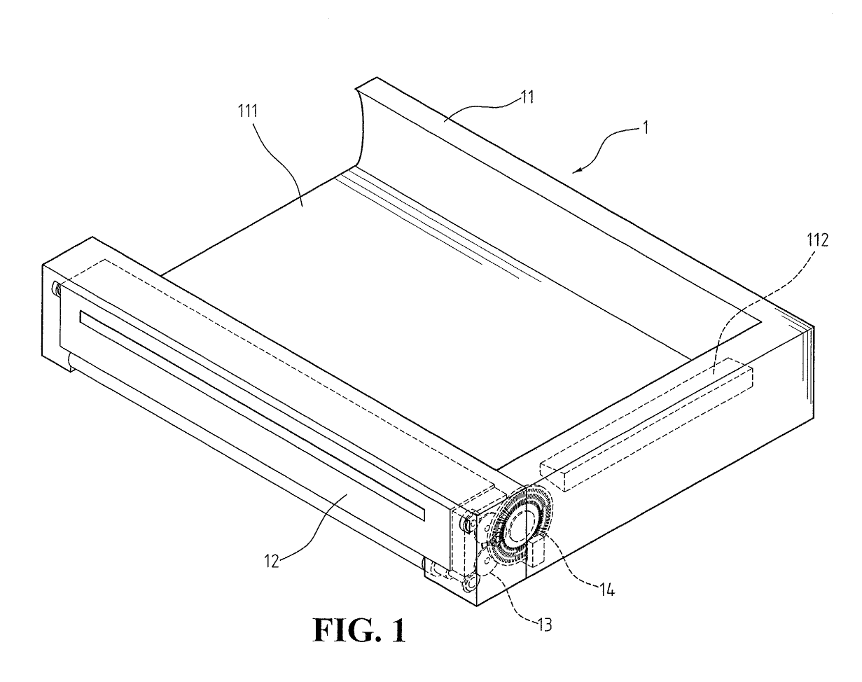

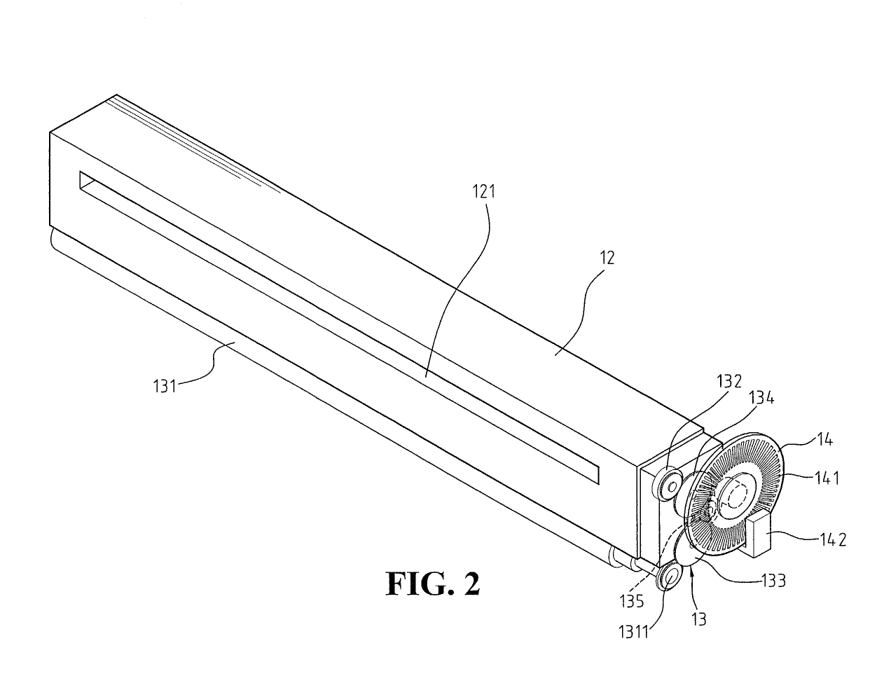

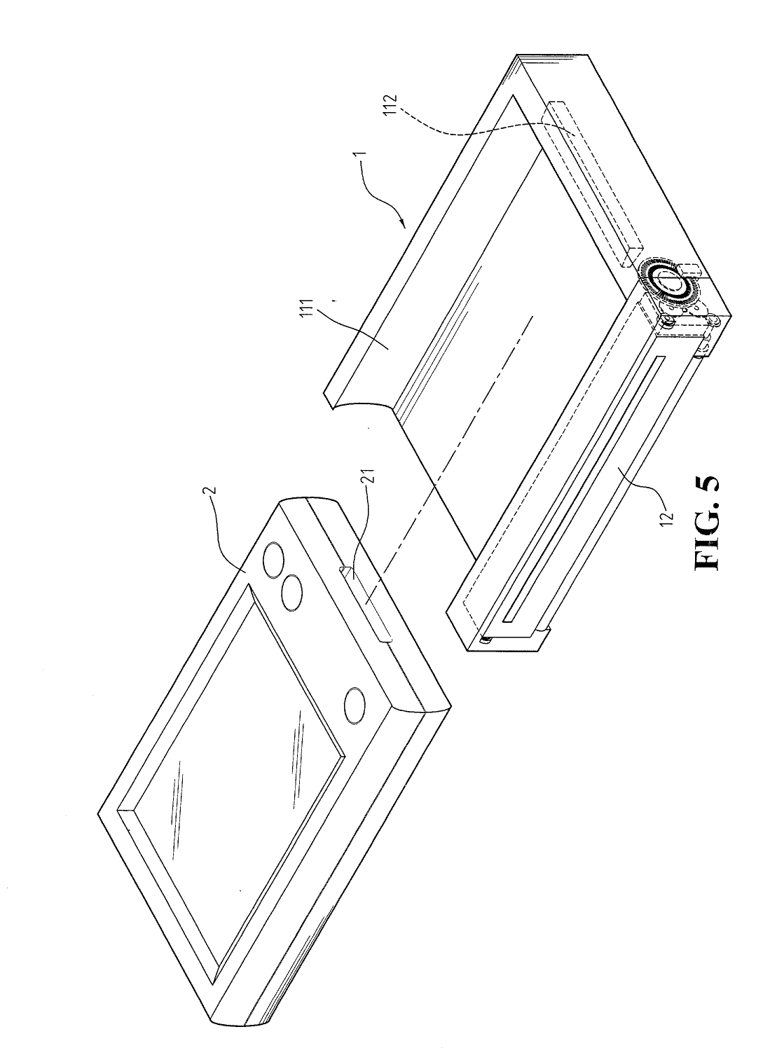

Referring to FIGS. 1 and 2, the scanning device 1 of the present invention comprises a body that has an engaging recess 111 defined between two ridges 11 on two sides of the body. The engaging recess 111 includes an open end and a close end in which a connection port 112 is defined. A PDA 2 as shown in FIG. 5 is received in the engaging recess 111 from the opening end and is connected to the connection port 112 by its connecting port 21.

A scanner 12 is received in one of the two ridges 11 and a scanning window 121 is defined in an outside of the scanner 12. An active shaft 131 is connected to a side of the scanner 12 and a first gear wheel 1311 is connected to an end of the active shaft 131. The first gear wheel 1311 is located at outside of the body of the scanning device 1. A second gear wheel 132 is connected to the other side of the scanner 12 and located at outside of the body of the scanning device 1.

A transmission assembly 13 is received in the ridge 11 in which the scanner 12 is received and includes a first gear 133 and a second gear 134 which are respectively engaged with the first gear wheel 1311 and the second gear wheel 132. A pinion 135 is located between the first gear 133 and the second gear 134 and are engaged with the first gear 133 and the second gear 134.

An optical sensing assembly 14 is co-rotatably engaged with the transmission assembly 13 and includes an optical mask 141 and an optical receiving member 142 which is located at a position from which a gap is defined between the optical mask 141 and the optical receiving member 142. The pinion 135 is co-axially connected to a third gear 1350 which is engaged with a shaft of the optical mask 141 so that when the transmission assembly 13 is activated, the optical mask 141 is rotated.

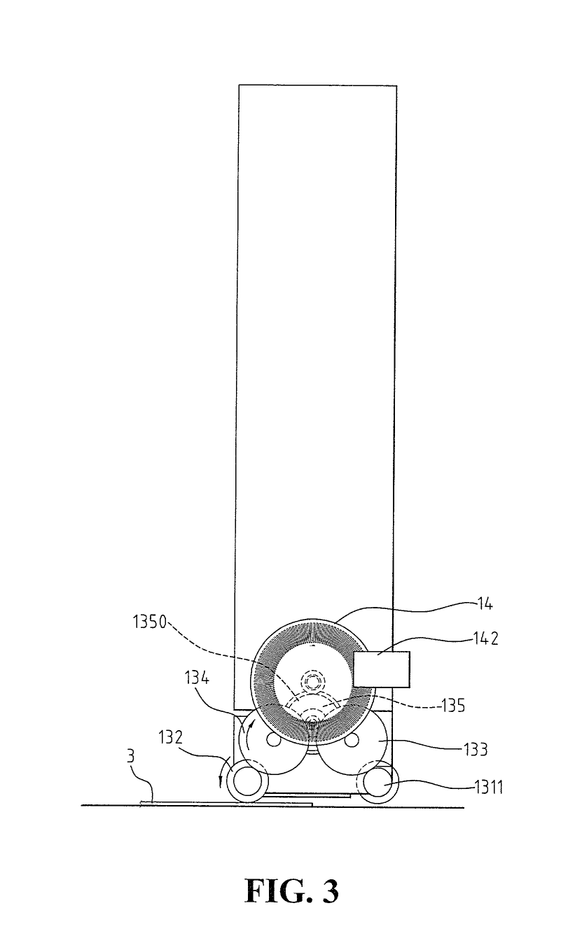

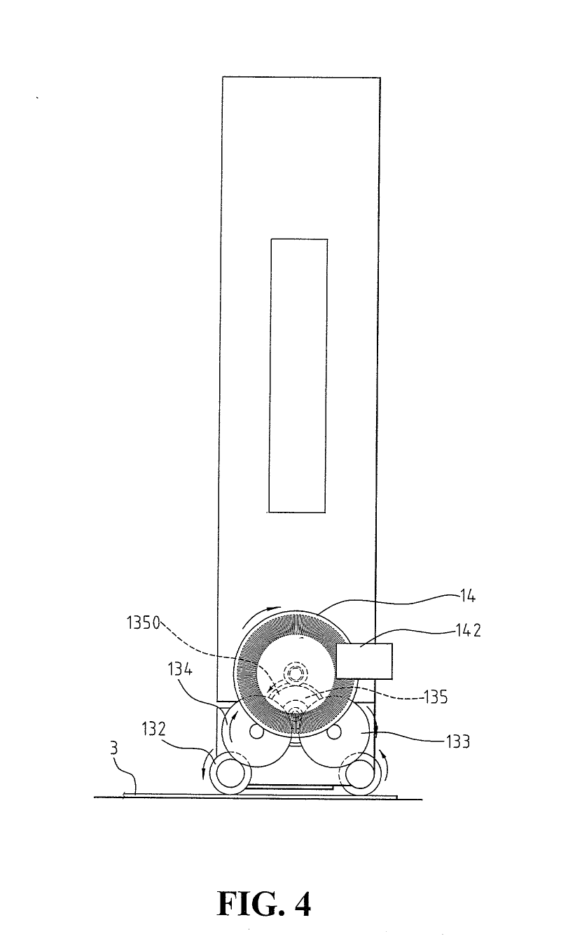

As shown in FIGS. 3 and 4, when scanning document 3, the second gear wheel 132 is first rolled on the document 3 and then the first gear wheel 1311 rolls on the document 3. The transmission assembly 13 is then activated wherein the first gear 133, the second gear 134 and the pinion 135 are rotated in the respective directions as shown by the arrow heads. By the operation of the optical sensing device 14, the user knows the speed of moving the scanning device 1 and adjusts the receiving speed of the image accordingly so as to provide high quality scanning feature. The first gear wheel 1311 is made of material that has high friction so that the first gear wheel 1311 is less likely rotated without touching the document 3. The scanning window 121 is located between the first gear wheel 1311 and the second gear wheel 132 so that the document is scanned from the very beginning thereof.

While we have shown and described the embodiment in accordance with the present invention, it should be clear to those skilled in the art that further embodiments may be made without departing from the scope of the present invention.

What is claimed is:

1. A scanning device comprising:
an engaging recess defined between two ridges on two sides of a body of the scanning device, the engaging recess including an open end and a close end in which a connection port is defined which is adapted to be connected to a PDA;
a scanner received in one of the two ridges and a scanning window defined in an outside of the scanner, an active shaft connected to a side of the scanner and a first gear wheel connected to an end of the active shaft, the first gear wheel located at outside of the body of the scanning device, a second gear wheel connected to the other side of the scanner and located at outside of the body of the scanning device, a transmission assembly engaged with the first gear wheel and the second gear wheel; and
an optical sensing assembly co-rotatably engaged with the transmission assembly.

2. The device as claimed in claim 1, wherein the transmission assembly includes a first gear and a second gear respectively engaged with the it gear wheel and the second gear wheel, a pinion located between the first gear and the second gear and engaged with the first gear and the second gear, the pinion co-axially connected to a third gear which is engaged with a shaft of the optical mask.

3. The device as claimed in claim 1, wherein the optical sensing assembly includes an optical mask and an optical receiving member which is located at a position from which a gap is defined between the optical mask and the optical receiving member.
